(19) United States
(12) Patent Application Publication
(10) Pub. No.: US 2019/0311600 A1
(43) Pub. Date: Oct. 10, 2019

(54) SYSTEM AND METHOD FOR DETECTING THE PRESENCE OF LIQUID WATER IN SANDWICH STRUCTURES

(71) Applicant: LEONARDO S.P.A., ROMA (IT)

(72) Inventors: Michele IANNONE, TORRE ANNUNZIATA (Napoli) (IT); Giampiero COPPOLA, NAPOLI (IT)

(21) Appl. No.: 16/372,843

(22) Filed: Apr. 2, 2019

(30) Foreign Application Priority Data
Apr. 10, 2018 (IT) 102018000004349

(51) Int. Cl. G08B 21/20; B32B 3/12; B64D 45/00

(52) U.S. Cl. CPC G08B 21/20; B32B 2605/18; B64D 45/00; B32B 3/12

(57) ABSTRACT

A system for detecting liquid water in a sandwich structure, the sandwich structure comprising two outer skins and a honeycomb core that rigidly interconnects the outer skins, and wherein is obtained a plurality of cells closed at opposite ends by the two outer skins, the cells being further configured to be in fluid communication with each other, wherein the system comprises at least one sensor placed within one of said cells, the sensor being sensitive to the presence of free liquid water within the cells, and a processing unit configured to receive an output signal provided by the sensor and issue a warning in case of the presence of free liquid water within the cells.

### CROSS-REFERENCE TO RELATED APPLICATIONS

This application claims priority to Italian Patent Application No. 102018000004349 filed on Apr. 10, 2018, the entire contents of which is hereby incorporated by reference.

### BACKGROUND OF THE INVENTION

The present invention refers in general to monitoring systems of aeronautical structures.

In aeronautics, sandwich structures are often used, i.e. structures made up of two outer skins, separated by a very light core, generally made up of a honeycomb structure that separates them, allowing great flexural stiffness with a limited increase in weight. The sandwich structures may be: metallic, with skins generally made of aluminum (and sometimes titanium) and honeycomb cores made of the same material; or non-metallic, with skins made of carbon, glass or aramid fiber and polymer matrix composite and glass or aramid fiber-reinforced honeycomb cores. In both cases the skin and honeycomb are glued with adhesive films.

The lightness and also the relatively competitive cost of the sandwich structures has fostered their widespread use in aeronautics. The sandwich structure with honeycomb core is however vulnerable to a problem that may limit its service life, also reducing the reliability thereof: the possibility of liquid water entering the core.

In effect, the skins are generally quite thin; the problem of the entry of liquid water may occur when the skin has breakages (even at a microscopic level) that compromise the integrity, or even, for very thin skins, porosity. The entry of water into the sandwiches for aeronautical use is also facilitated by the pressure cycles to which the sandwiches are exposed in use. In effect, in the stage of the aircraft increasing in altitude following take-off, the pressure outside the sandwich tends to decrease, and, if the sandwich is hermetically sealed, stress is created from the inside to the outside; conversely, in the stage of decreasing in altitude before landing, the pressure outside the sandwich tends to rise; this, in the presence of breakages in the skins, causes a pressure differential from the outside to the inside that, especially when passing through clouds, facilitates the entry of drops of water into the honeycomb. The phenomenon is certainly negative, also because the liquid water inside the honeycomb during flight cycles is also exposed to severe drops in temperature that cause it to solidify, with the effect of breaking the honeycomb cells through thermal expansion resulting from the solidification. The use of both metal and composite sandwich structures is therefore limited by the need for frequent checks on the presence of liquid water inside the honeycomb core. One of the methods used is infrared thermography, which is particularly sensitive to the presence of water.

### SUMMARY OF THE INVENTION

One purpose of the present invention is to make available a system for detecting the presence of free liquid water in sandwich structures.

For this purpose, an object of the invention is a system for detecting liquid water in a sandwich structure, the sandwich structure comprising two outer skins and a honeycomb core that rigidly interconnects the outer skins, and wherein is obtained a plurality of cells closed at opposite ends by the two outer skins, said cells being further configured to be in fluid communication with each other, wherein the system comprises
at least one sensor placed within one of said cells, said sensor being sensitive to the presence of free liquid water within said cells, and
a processing unit configured to receive an output signal provided by the sensor and to issue a warning in the event of the presence of free liquid water within said cells.

Moreover, an object of the invention is a method for detecting liquid water in a sandwich structure, the sandwich structure comprising two outer skins and a honeycomb core that rigidly interconnects the outer skins, and wherein is obtained a plurality of cells closed at opposite ends by the two outer skins, said cells being further configured to be in fluid communication with each other,
there being provided at least one sensor placed within one of said cells, said sensor being sensitive to the presence of free liquid water within said cells,
wherein the method comprises:
receiving an output signal provided by the sensor and
issuing a warning in case of the presence of free liquid water within said cells.

### BRIEF DESCRIPTION OF THE DRAWINGS

Some preferred but non-limiting embodiments will now be described; making reference to the accompanying drawings, wherein:

FIG. 1 is a schematic cross-section view of a portion of a sandwich panel, fitted with a monitoring system according to the invention; and

FIG. 2 is a schematic plan view of the portion of the sandwich panel shown in FIG. 1.

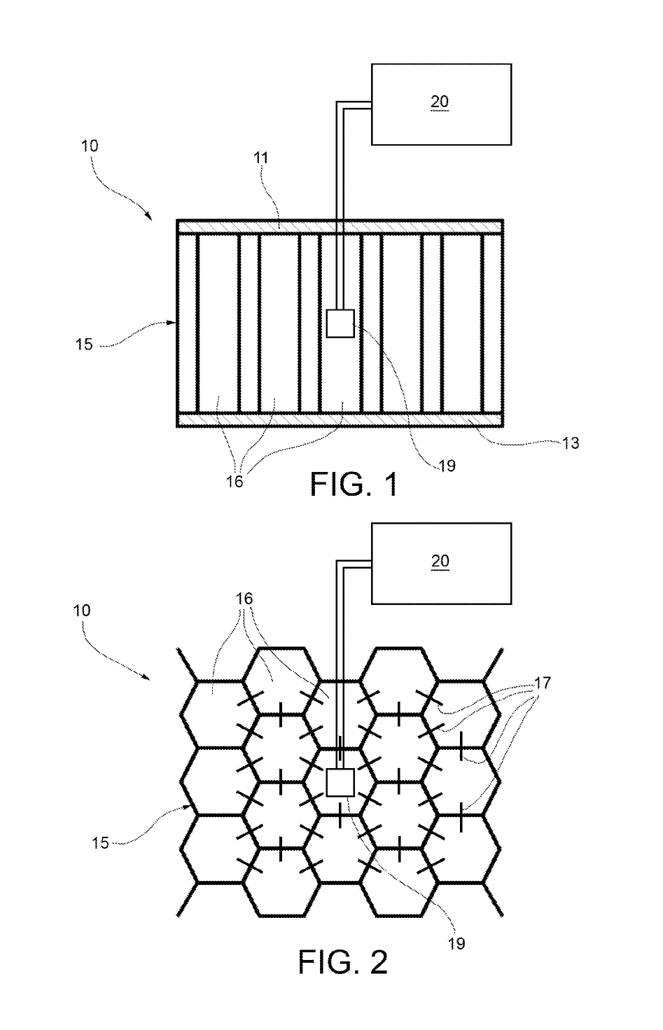

### DETAILED DESCRIPTION

With reference to the figures, a portion of a sandwich structure is represented, indicated collectively at 10.

The sandwich structure 10 comprises two outer skins respectively 11 and 13, and a honeycomb core 15 that rigidly interconnects the outer skins 11 and 13.

The outer skins 11, 13 may be made of metallic material or composite material, comprising a fiber-reinforced resin matrix.

The honeycomb core 15 may be made of metallic material or composite material, comprising a fiber-reinforced resin matrix.

The skins 11 and 13 are fixed on the two opposite sides of the honeycomb core 15, for example, by means of a structural adhesive.

In the core 15 therefore is obtained a plurality of cells 16 that are closed on opposite ends by the two outer skins 11 and 13. The cells 16 are also configured to be in fluid communication with each other, for example, through holes made in the walls of the honeycomb material that separate the cells 16 from each other. In FIG. 2, the passages for the fluid are schematically represented by dashes 17 that interconnect adjacent cells 16.

At least one sensor 19 is located within one of the cells 16. Such sensor 19 is sensitive to the presence of free liquid water inside the cells 16. In particular, the sensor 19 is a humidity sensor. In the presence of liquid water, the humidity in the volume inside the core 15 is about 100%, since the core 15 is made in such a way as to allow intercommunication between the cells 16.

The use of a humidity sensor, for example based on the measurement of electrical capacity, allows the presence of water to be signaled through the reading of internal humidity equal to 100% (with the measurement tolerance of the sensor).

A processing unit 20, arranged, for example, on board an aircraft on which the sandwich structure 10 is present, is configured to receive an output signal from the sensor 19. The processing unit 20 may be connected to the sensor 19 by wire or wirelessly.

Based on the output signal provided by the sensor 19, the processing unit 20 may emit a visual and/or audible warning if free liquid water is present in the cells 16 of the sandwich structure 10.

1. A system for detecting liquid water in a sandwich structure, the sandwich structure comprising two outer skins and a honeycomb core that rigidly interconnects the outer skins, and wherein is obtained a plurality of cells closed at opposite ends by the two outer skins, said cells being further configured to be in fluid communication with each other, wherein the system comprises
at least one sensor placed within one of said cells, said sensor being sensitive to the presence of free liquid water within said cells, and
a processing unit configured to receive an output signal provided by the sensor and issue a warning in case of the presence of free liquid water within said cells.

2. System according to claim 1, wherein said sensor is a humidity sensor, and the processing unit is configured to issue a warning in case of relative humidity detected by the sensor equal to about 100%.

3. System according to claim 1, wherein said outer skins are made of metal material or of composite material, comprising a matrix of fiber-reinforced resin.

4. A system according to any of claims 1, wherein said honeycomb core is made of metallic material or of non-metallic material, reinforced with aramid or glass fibers.

5. A method for detecting liquid water in a sandwich structure, the sandwich structure comprising two outer skins and a honeycomb core that rigidly interconnects the outer skins, and wherein is obtained a plurality of cells, closed at opposite ends by the two outer skins, said cells being further configured to be in fluid communication with each other,
there being provided at least one sensor placed within one of said cells, said sensor being sensitive to the presence of free liquid water within said cells,
wherein the method comprises:
receiving an output signal provided by the sensor and
issuing a warning in case of the presence of free liquid water within said cells.

6. A method according to claim 5, wherein said sensor is a humidity sensor, and wherein the method comprises:
issuing a warning in case of relative humidity detected by the sensor (19) equal to about 100%.

7. A method according to claim 5, wherein said outer skins are made of metal material or of composite material, comprising a matrix of fiber-reinforced resin.

8. A method according to any one of claims 5, wherein said honeycomb core is made of metal material or of non-metal material, reinforced with aramid or glass fibers.
